(19) United States
(12) Patent Application Publication
(10) Pub. No.: US 2003/0127076 A1
(43) Pub. Date: Jul. 10, 2003

(54) Fuel-heating system for diesel engine

(76) Inventor: Heru Prasanta Wijaya, Kali Kendal (ID)

Correspondence Address: CHRISTIE, PARKER & HALE, LLP, P.O. BOX 7068, PASADENA, CA, 91109-7068, US

(21) Appl. No.: 10/307,260

(22) Filed: Nov. 27, 2002

Related U.S. Application Data
(63) Continuation-in-part of application No. PCT/IB00/00731, filed on May 30, 2000.

(51) Int. Cl. F02G 5/00

(52) U.S. Cl. 123/557

(57) ABSTRACT

A system for preheating diesel fuel before being introduced into a chamber of an internal combustion engine, particularly before or during passing of the fuel through a fuel filter, is provided. The system includes a filtering element and a preheating element, where the heat needed to reach the burning point of the diesel fuel with the presence of preheating will be less in amount compared to the system without preheating. In addition, compression heat with fuel preheating will remain constant so the combustion of the diesel fuel will be relatively perfect improving diesel engine performance.

### CROSS-REFERENCE TO RELATED APPLICATION

This application is a continuation-in-part of International Application No. PCT/IB00/00731, filed May 30, 2000.

### FIELD OF INVENTION

This present invention relates to a fuel-heating system for a diesel engine, particularly to a diesel fuel-heating system used within or with a fuel filter, and more specifically to a diesel fuel heating system which heats the fuel when it passes the fuel filter.

### BACKGROUND OF INVENTION

It is widely known that the freezing of paraffin in diesel fuels causes clogging of the fuel filter element. When the ambient temperature is relatively low, some problems arise in the operation of internal combustion engines, particularly diesel engines.

The clogging of filter elements of the engine owing to the freezing of paraffin during cold weather can be prevented by preheating the diesel fuel before introducing it into the chamber of an internal combustion engine. The preheating of fuel causes fuel volume expansion and in turn apparently increases engine efficiency. Despite its main function of preventing problems related to freezing in internal combustion engines, particularly diesel internal combustion engines, methods must be considered to solve the related environmental hazards such as particles emission in the surrounding atmosphere.

The application of this inventive preheating system improves the combustion performance of the diesel fuel in the internal combustion engines, improves engine performance and minimizes the combustion residue expelled to the atmosphere.

### SUMMARY OF INVENTION

In an exemplary embodiment, this invention provides a fuel-preheating system preceding the introduction of the fuel into a chamber, e.g., the combustion chamber of an internal combustion engine, for heating the fuel before and during passing through the fuel filter (referred to in this case ‘energized diesel fuel filter’), whereby less heat is needed to burn the fuel compared to the system applying no preheating action. In addition, owing to constancy of compression heat, the preheated diesel fuel whose combustion is relatively perfect, and will improve the diesel engines performance.

Another object of this invention is to provide a preheating system comprising two main parts, i.e. a filtering part and a preheating part which can eliminate to a maximum extent the emission of hazardous particles to the atmosphere due to the preheating, prevent the clogging of the filter elements due to the freezing of paraffin, improve engine efficiency and minimize production cost.

### BRIEF DESCRIPTION OF THE DRAWING

FIG. 1A is a sectional view of a basic construction of an energized diesel fuel filter where heat is derived from a fluid;

FIG. 1B is an enlarged view of section “A” shown in FIG. 1A;

FIG. 1C is a bottom view of the energized fuel filter shown in FIG. 1A;

FIG. 2 is a sectional view of the construction of an energized diesel fuel filter where heat is derived from a tubular heating element;

FIGS. 3A, 3B and 3C depict partial cross-sectional views of the construction of an energized diesel fuel filter with a heat exchanger to extract heat expelled from the engine exhaust gas;

FIG. 3D is an end view of the energized fuel filter with heat exchanger shown in FIGS. 3A-3C; and

FIG. 4 is schematic diagram of diesel fuel flow passing through a heat exchanger receiving heat from an exhaust gas.

### DETAIL OF THE INVENTION

An energized diesel fuel system according to this invention comprises substantially two components, i.e., a filtering element and a preheating element. Heat used in preheating can be extracted from the hot water radiator (engine-cooling water) and/or the engine-cooling lubricant, both of which are in the form of liquid, or from heat expelled from an exhaustive gas conduit or muffler, or from a heating element.

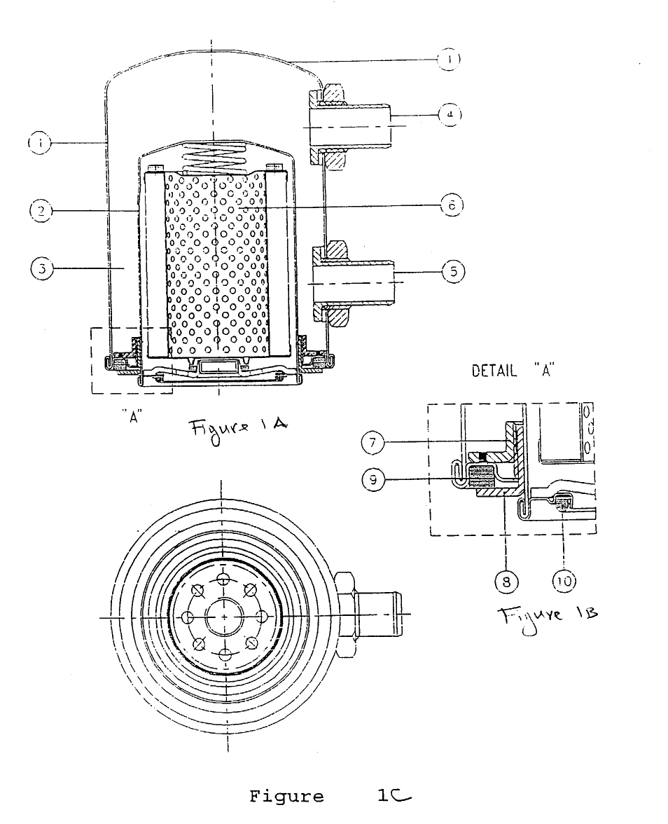

The basic construction of an energized diesel fuel filter with heat being extracted from a fluid is shown in FIGS. 1A, 1B and 1C. This construction comprises a cylindrical heat tube (1) in which a filter tube (2) having a lip threads (8) is disposed. Between the outer periphery of the filter tube housing (2) and the inner side of the heating tube housing (1), there is a heating fluid circulation chamber (3). Heating fluid originating from the flowing of the engine-cooling fluid (radiator, not shown) is introduced into the heating chamber (3) through heating fluid inlet channel (4). The fluid will further circulate in the heating chamber (3) to preheat the diesel fuel flowing into the filter tube (2). At the end of its circulation within the heating chamber (3), the heating fluid will be forced out through the outlet channel (5). The preheated diesel fuel in the filter tube (2) will then to be transferred into the combustion chamber of the internal combustion engine.

The filter tube (2) with lip thread (8) that consists of filter media (6) can be a replacement part, because the life service of filter media is relatively short compared to the other parts. Cylindrical heat tube (1) with connecting nut (7) has a long life service, so this part is not needed to be changed in the end of service life of the replacement parts. This is the way to reduce the maintenance cost if this part is installed on an internal combustion engine. To prevent fluid leakage between the replacement part and the cylindrical heat tube (1), a gasket (9) provided over the lip thread 8.

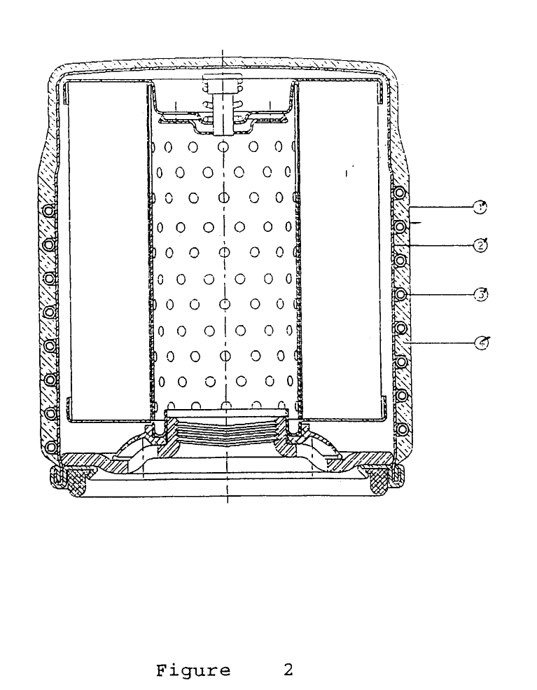

FIG. 2 shows a diesel fuel filter with a heating element. In this system, between an inner peripheral wall of the heating tube housing (1′) and outer peripheral wall of filter tube (2′), are disposed a plurality of tubular or pipe heating elements (3′), wherein heat is supplied from the outside. Heat energy that is supplied to the tubular heating element can be in fluid form, such as engine water-coolant, engine oil or hot air from the exhaust system. This hot fluid is circulated into tubular heating element. Heat energy from fluid inside tubular heating element will be transferred to the diesel fuel in the fuel filter. To isolate heat so as not to flow out from the heating tube housing (1′), the space between the inner peripheral wall of filter tube housing (2′) is covered with isolator (4′). Tubular heating element in FIG. 2, can be replaced by an electrical heating element. The electrical heating element converts electrical energy to heat.

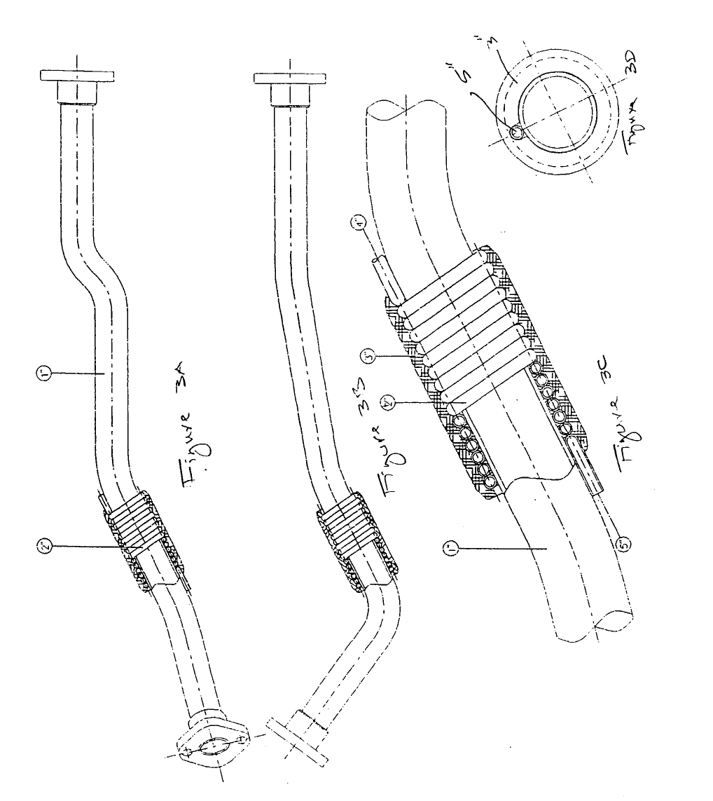

In FIGS. 3A-3D is shown the construction of a heat exchanger from the engine exhaust gas. Heat for preheating is obtained from the exhaust gas of the engine which is drawn from the exhaust gas flowing through the exhaust pipe 1″, wherein along the longitudinal part of the cylindrical gas exhaust pipe (1″) there is wounded a diesel fuel pipe coil (2″) with specified windings. Furthermore, the entire surface of the pipe coil is covered with an isolator (3″) that functions as a heat storage as well as an isolator for the heat exchanger that transfers heat from the exhaust gas so as not to directly communicate with the atmosphere. The diesel fuel flowing from the tank is introduced into the inlet (4″) at the beginning of the fuel pipe winding (2″) and expelled finally through the outlet (5″) at the end of coil winding of fuel channel pipe (2″).

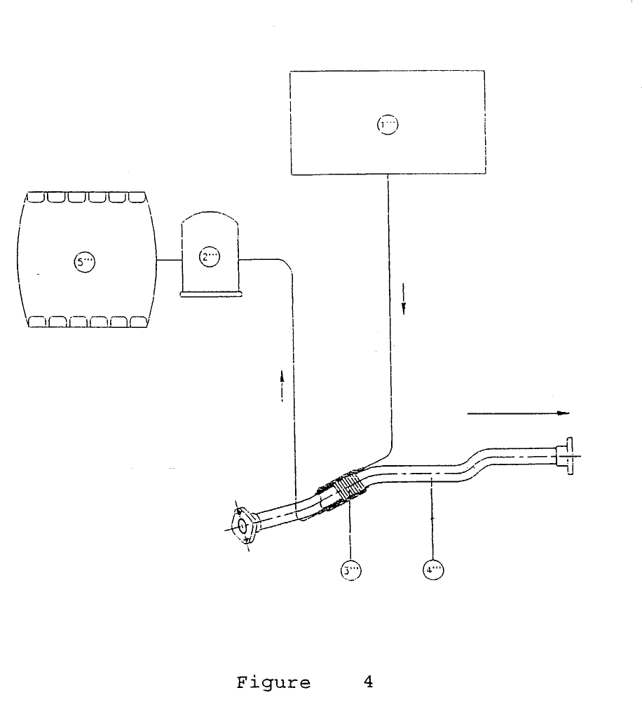

A scheme of diesel fuel flow through the heat exchanger as being disclosed in FIGS. 3A, 3B and 3C, is further shown in FIG. 4. FIG. 4 shows the diesel fuel originating from the fuel tank (1″′) before being introduced into the fuel filter (2″′); this diesel fuel flow channel is wounded (3″′) around the gas exhaust pipe (4″′) so as to be preheated conductively by the heat contained within gas exhaust pipe (4″′) and to be introduced in a preheated condition further into the combustion chamber (5″′) (after passing through filter (2″′)).

Due to preheating, it is expected that the combustion of diesel fuel within the engine will be more perfect so that the engine performance will increase and the residue of the combustion process will be minimized.

Of course, it should be understood that the scope of the invention is not limited to the description and the drawings attached. All the explanations disclosed within the description represent merely illustrative and explanatory. All variations and modifications can be applied by the persons skilled in the art as long as they are still in the scope of the following claims.

1. A system for preheating diesel fuel before being introduced into a combustion chamber of an internal combustion engine, the system comprising:
a filtering element comprising a filter tube having a filter media;
a preheating element comprising a heating tube for receiving a heated fluid from a vehicle or an engine cooling lubricant; and
a connecting nut coupling the filtering element to the preheating element.

2. The system of claim 1 further comprising a lip extending from the filtering element and a gasket adjacent to the lip.

3. The system of claim 1 wherein the filtering element is a replacement part.

4. A system for preheating diesel fuel before being introduced into a combustion chamber of an internal combustion engine, the system comprising:
a filter tube;
a heating element wound around the filter tube; and
an insulator covering the heating element.

5. The system of claim 4 wherein the heating element is a tube for receiving a heated fluid from a vehicle or an engine cooling lubricant.

6. The system of claim 4 wherein the heating element is an electric heating element.

7. A system for preheating diesel fuel before being introduced into a combustion chamber of an internal combustion engine, the system comprising:
a vehicle exhaust conduit;
a fuel line carrying the fuel to be heated, said fuel line being coiled around the exhaust conduit; and
an insulator covering the coiled fuel line.

8. A system for preheating diesel fuel before being introduced into a chamber of an internal combustion engine, particularly before the fuel passes the fuel filter, the system comprising:
a filtering element characterized by the filtering element being a replacement part which consists of a filter tube with a lip thread and filter media;
a preheating part which consist of a heating tube with a connecting nut;
a gasket below the lip thread for preventing fluid leakage between the replacement part and the preheating part, wherein heat energy is received in the preheating part, wherein the heat energy is derived from a water radiator or engine-cooling water, or from an engine-cooling lubricant.

9. A system for preheating diesel fuel before being introduced into a chamber of an internal combustion engine when the fuel passes a fuel filter comprising a tubular heating element wound around the fuel filter and covered by insulator.

10. The system for preheating diesel fuel as recited in claim 9, wherein the tubular heating element is an electrical heating element.
